(19) United States
(12) Patent Application Publication
(10) Pub. No.: US 2007/0017614 A1
(43) Pub. Date: Jan. 25, 2007

(54) Foam insert designed to be incorporated into an assembly for running at reduced pressure

(75) Inventor: Philippe Tramond, St-Ours-Les-Roches (FR)

Correspondence Address: COHEN, PONTANI, LIEBERMAN & PAVANE, 551 FIFTH AVENUE, SUITE 1210, NEW YORK, NY, 10176, US

(73) Assignee: Michelin Recherche et Technique S.A., Granges-Paccot (CH)

(21) Appl. No.: 11/479,262

(22) Filed: Jun. 30, 2006

(30) Foreign Application Priority Data
Jun. 30, 2005 (FR) 05/06752
Oct. 19, 2005 (FR) 05/10726

(51) Int. Cl. B60C 17/00

(52) U.S. Cl. 152/152

(57) ABSTRACT

A foam insert (5) designed to occupy the inner space formed by a tire (2) and a rim (3) equipped with an inflation valve (4), comprising a duct (53) whose walls are airtight and which passes through the inside of the volume of said foam insert (5), characterised in that a wick (56) is disposed inside the duct (53).

### FIELD OF THE INVENTION

The invention relates to run flat assemblies intended to be fitted on motor vehicles. These assemblies comprise a rim equipped with a valve and a tire, and enclose an insert approximately toroidal in shape. This insert, more commonly known as a foam insert, is generally made of closed-cell cellular rubber. It is designed to bear the load in the event of the tire losing pressure. The cells may, in some cases, contain a pressurised gas.

### BACKGROUND OF THE INVENTION

Safety devices of this type are known from the prior art and numerous variant embodiments have been proposed. One of them is disclosed in patent FR 1 450 638, which explains the operating principle thereof and describes the behaviour of the foam insert under the effect of centrifugal force. This publication also proposes improving the stability of the foam insert on the rim by using the inflation pressure to keep the foam insert flattened against the rim.

In order to achieve this effect, it is proposed to place a leakproof annular membrane, or alternatively a leakproof film, at the intermediate point between each of the sidewalls of the insert and the internal wall of each of the beads of the tire casing in order to create a first compartment in communication with the atmosphere and a second compartment at the utilisation pressure of the tire. Thus, the radially inner face of the insert is in contact with atmospheric pressure, and the inflation pressure acts on the radially outer face of the insert.

The difference in pressure between the two compartments produces a radially inwardly directed force acting on the foam insert and having the effect of flattening said insert on the rim by compressing the gas contained in the cells. The action of the inflation pressure has the consequence of reducing the volume of said insert, which makes it possible to avoid all contact between the internal wall of the tire and the foam insert. This force also opposes the centrifugal force and assists in holding the insert in position against the rim when the vehicle reaches an elevated speed.

When the pressure in the tire casing falls below a certain threshold, the foam insert resumes its natural shape, occupying all the internal volume of the tire casing, so contributing to support of the tire.

It turns out, in fact, that good functioning of these assemblies is related to the quality of positioning of the annular membrane and to formation of the leakproof joint of said annular membrane with the internal wall of the tire beads, a fact which may bring about a certain number of drawbacks during mounting and demounting operations.

### SUMMARY OF THE INVENTION

The object of the present invention is to propose a simplified assembly allowing these problems to be eliminated, and in which the tire and the foam insert are firmly connected.

This assembly is characterised in that the base of each of the sidewalls of the foam insert is adhesively bonded in leakproof manner and over the entire length of its circumference to a part of the inner surface of each of the beads of the tire which it faces.

The leakproof joint obtained by adhesively bonding the foam insert to the tire makes it possible to separate the first compartment in contact with the atmosphere and the second compartment brought up to inflation pressure.

This particular embodiment is made possible by the addition of a channel which passes through the inside of the foam insert, is connected by one of its ends to the inflation valve and leads at the other of its ends into the second compartment.

Publication EP 0748 706 describes an assembly comprising a tire and a internal support of foam whose edges are adhesively bonded to the internal wall of the tire and through which passes a channel. However, this publication does not deal with the specific problem of assemblies using the inflation pressure to hold an expandable foam insert in place.

### BRIEF DESCRIPTION OF THE DRAWINGS

FIG. 1 shows a radial section through an assembly in accordance with the invention.

FIG. 2 shows a particular configuration of the second duct.

### DETAILED DESCRIPTION OF THE DRAWINGS

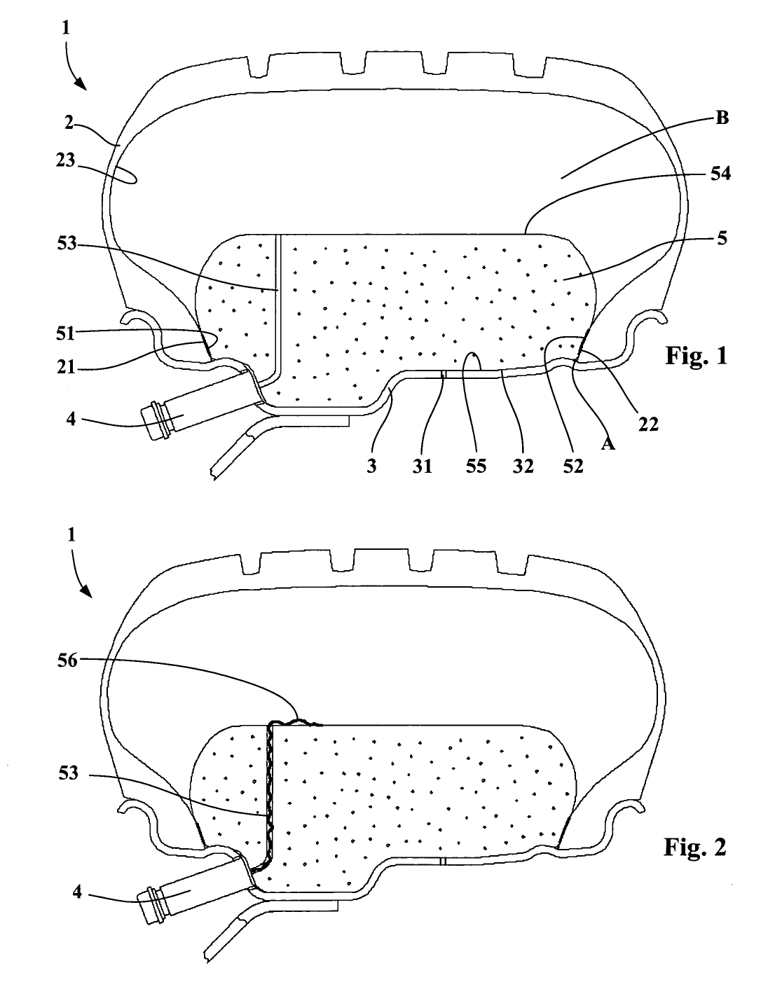

FIG. 1 shows a radial section through an assembly 1 comprising a tire 2 mounted on a rim 3. A foam insert 5 is disposed in the internal space situated between the wall of the tire 23 and the radially outer wall 32 of the rim 3.

The base of each of the sidewalls 51 and 52 of the foam insert is adhesively bonded in leakproof manner to that part of the inner surface of each of the beads 21 and 22 of the tire 2 which it faces. The joint between these two parts is formed over the entire length of the circumference, so as to form two compartments A and B isolated from one another. This adhesive bonding is effected using adhesive bonding techniques conventionally used to bond together products manufactured on the basis of rubber materials.

Thus, in addition to the pressure forces causing the foam insert to be flattened against the rim, the adhesively bonded joint provides additional strength which assists in holding the foam insert in contact with the rim when the centrifugal forces increase in association with travel speed.

The first compartment A situated between the base 55 of the foam insert 5 and the radially outer wall 32 of the rim 3 is in communication with atmospheric pressure by means of an air inlet 31. The second compartment B is defined by the internal surface 23 of the tire 2 and the radially outer surface 54 of the foam insert. A duct 53 connects the compartment B to the valve 4. Since the duct 53 is situated within the volume of the foam insert itself, there is no difficulty in achieving a leakproof seal between the wall of the base of the sidewalls 51 and 52 of the foam insert and the internal wall 21 and 22 of the bead.

Preferably, the radially outer surface 54 of the foam insert 5 is rendered airtight in the same way as the internal surface 23 of the tire 2, in such a way that compartment B may be kept at inflation pressure. This property is generally achieved without difficulty by selecting a butyl-based material for producing the outer wall of the foam insert.

The duct 53 is made in such a way that it passes through the volume of the foam insert 5. This second duct is capable of being connected by one of its ends to said inflation valve (4) and opens at the other of its ends into compartment B, specifically substantially in the part of the foam insert facing the internal wall of the tire situated above the beads of said tire. The walls of this second duct are preferably airtight.

However this duct 53 must be produced with the greatest possible care, so as to ensure that it is not closed when the pressure increases or in the event of deflation of compartment B. In effect, pressurisation has the effect of compressing the foam insert and causing deformation of the duct 53. In practice, it was noted that a substantially radial duct which is circular in form enabled the achievement of satisfactory results. The diameter of this second duct is approximately 3 to 5 mm when the foam insert is free.

The embodiment as illustrated in FIG. 2 consists of arranging a wick 56 in the duct 53 so as to allow the passage of air whatever deformations the foam insert undergoes. The wick 56 consists for example of a textile cord.

This duct 53 may be produced without difficulty during manufacture of the foam insert. To this end a metal needle of suitable form is arranged in the blank of the foam insert before vulcanisation. Said rod may easily be extracted after final shaping of the foam insert due to the considerable flexibility of the material generally used and the increase in diameter of the duct during expansion of the foam insert. A skin also airtight in nature is then formed on the surface of the duct.

This method of manufacture is to be preferred to that which consists in drilling a channel through the body of the foam insert. In effect, during the latter operation the cells of the foam are torn, which has the effect of creating incipient breakage points which are detrimental to the service life of the foam insert in the event of travel under reduced pressure.

The valve 4 is connected to the outlet of the duct 53. A preferred embodiment consists in adhesively bonding the valve directly to the foam insert in line with the mouth part of the duct 53. It is also entirely possible to arrange a base (not shown) comprising a hollow extension piece positioned perpendicularly to the plane of the base and in which the duct 53 opens. The valve 4 may then be coupled to the end of the extension piece by screwing or by any other suitable means.

An assembly formed of the tire 2 and the foam insert 5 is then obtained which exhibits the characteristic of being suitable for sale in this form, so making use of a safety assembly of this type more convenient and more economical. In effect, the fitter no longer has to perform the long and tricky operations involved in positioning and adhesively bonding a leakproof membrane, and the tire thus equipped may be mounted on the rim using a standard process.

The assembly 1 comprising a rim and a tire firmly connected to the foam insert is also safer, in that, in normal use, the risk of pressure loss inside the second compartment B is not associated with a loss of leakproofness at the level of the partition with the first compartment A.

In the event of puncture of the tread, the foam insert deploys inside the cavity of the tire and allows the user continue on his/her journey in all safety until assistance can be found. It will be noted that, under these conditions, repair operations are performed via the outer surface of the tread.

It goes without saying that the preferred embodiment of the invention relates to the assembly in which the tire and the foam insert are firmly connected with one another and marketed in this form. It is nevertheless possible, in order to improve vehicle flat running, to provide fitters who so desire with a foam insert suitable for being arranged in a tire and adhesively bonded in leakproof manner as has just been described in the above paragraphs.

This foam insert has the special feature of comprising a duct 53 which is substantially airtight and passes through the inside of the internal volume thereof.

Assembly of the foam insert and the tire is performed by the fitter him/herself, said fitter needing to have at his/her disposal means allowing him/her to perform leakproof adhesive bonding and to respect the instructions associated with this type of operation and known to the person skilled in the art.

The mounting method, which covers all the operations involved in assembling the foam insert, the tire and the rim, thus comprises a stage consisting in adhesively bonding, in leakproof manner and over the entire length of the circumference thereof, the base of the sidewalls 51, 52 of the foam insert 5 to a part of the inner surface of each of the beads 21, 22 of the tire 2 which it faces.

We claim:

1. A foam insert (5) designed to occupy the inner space formed by a tire (2) and a rim (3) equipped with an inflation valve (4), comprising a duct (53) whose walls are airtight and which passes through the inside of the volume of said foam insert (5), wherein a wick (56) is disposed inside the duct (53).

2. The foam insert according to claim 1, in which the radially outer surface (54) of the foam insert (5) is substantially airtight.

3. The foam insert according to claim 1, in which said duct (53) is capable of being connected by one of its ends to said inflation valve (4) and opens at the other of its ends at the part of the foam insert (5) intended to be placed facing the internal wall of the tire (23) situated above the inner surface of the beads (21, 22) of said tire (2).

4. An assembly (1) formed of a wheel comprising a rim (3) equipped with an inflation valve (4), a tire (2) mounted on said rim of said wheel, and a foam insert (5) placed inside a volume defined by the internal wall of the tire (2) and the rim (3) of the wheel, in which assembly the base of each of the sidewalls (51, 52) of the foam insert (5) is adhesively bonded, in leakproof manner and over the entire length of the circumference thereof, to a part of an inner surface of each of the beads (21, 22) of the tire (2) which it faces, wherein the assembly comprises a foam insert according to claim 1.

5. The assembly (1) according to claim 4, in which the volume between the rim and the base of the foam insert forms a first compartment (A) in communication with the atmosphere via an air inlet (31), and the volume between the internal wall (23) of the tire (2) and the radially outer surface (54) of the foam insert (5) forms a leakproof second compartment (B) communicating with the inflation valve (4) via the duct (53) and inflated to the utilisation pressure of the tire.
